(19) United States
(12) Patent Application Publication
(10) Pub. No.: US 2018/0285471 A1
(43) Pub. Date: Oct. 4, 2018

(54) PAGE CACHING METHOD AND APPARATUS

(71) Applicant: Shanghai Xiaoyi Technology Co., Ltd., Shanghai (CN)

(72) Inventors: Dening HAO, Beijing (CN); Changjiang WEI, Beijing (CN); Qing HAO, Beijing (CN)

(73) Assignee: Shanghai Xiaoyi Technology Co., Ltd.

(21) Appl. No.: 15/941,251

(22) Filed: Mar. 30, 2018

(30) Foreign Application Priority Data
Mar. 31, 2017 (CN) 201710208351.5

(51) Int. Cl. G06F 17/30; G06F 12/0895

(52) U.S. Cl. CPC G06F 17/30902; G06F 12/0895; G06F 2212/45; G06F 2212/163; G06F 2212/1024

(57) ABSTRACT

A method and apparatus for caching webpages, the method including: configuring a caching area in a memory and caching content of a currently accessed page in one or more current-page caching blocks of the caching area; determining a page accessing direction; when the page accessing direction is downward, preloading first content of at least one page that continues in the downward direction from the currently accessed page, and caching the first content in a downward caching block of the caching area; and when the page accessing direction is upward, preloading second content of at least one page that continues in the upward direction from the currently accessed page, and caching the second content in an upward caching block of the caching area. The one or more current-page caching blocks, downward caching block, and upward caching block are different blocks of the caching area.

### CROSS-REFERENCE TO RELATED APPLICATION

This application is based upon and claims priority from Chinese Patent Application No. 201710208351.5, filed on Mar. 31, 2017, the disclosure of which is expressly incorporated herein by reference in its entirety.

### TECHNICAL FIELD

The present disclosure generally relates to computer technology, and more specifically to a page caching method and apparatus.

### BACKGROUND

When using a computer application to display webpages, especially webpages containing large amount of images, a user often experiences slow loading and poor dynamic performance of the webpages. These problems are aggravated in embedded systems because their processor capacity and memory space are subject to greater limitations.

Typically, when the user operates a terminal to access webpages downward (e.g., scroll down a webpage or moving from the current webpage to a lower-layer webpage), the terminal preloads the page content that continues in the downward direction and displays the preloaded content in a scrolling manner. This way, better dynamic display performance can be achieved. However, when the user accesses the webpages upward (e.g., scrolling up a webpage or moving from the current webpage to an upper-layer webpage), loading is often slow and display is inefficient.

The disclosed methods and systems address one or more of the problems listed above.

### SUMMARY

Consistent with one embodiment of the present disclosure, a page caching method is provided. The method includes configuring a caching area in a memory and caching content of a currently accessed page in one or more current-page caching blocks of the caching area; determining a page accessing direction; when the page accessing direction is downward, preloading first content of at least one page that continues from the currently accessed page in the downward direction and caching the first content in a downward caching block of the caching area; and when the page accessing direction is upward, preloading second content of at least one page that continues from the currently accessed page in the upward direction and caching the second content in an upward caching block of the caching area. The one or more current-page caching blocks, downward caching block, and upward caching block are different blocks of the caching area.

Consistent with another embodiment of the present disclosure, a page caching apparatus is provided. The apparatus includes a memory storing instructions and a processor. The processor is configured to execute the instructions to: configure a caching area in the memory and cache content of a currently accessed page in one or more current-page caching blocks of the caching area; determine a page accessing direction; when the page accessing direction is downward, preload first content of at least one page that continues in the downward direction from the currently accessed page and cache the first content in a downward caching block of the caching area; and when the page accessing direction is upward, preload second content of at least one page that continues in the upward direction from the currently accessed page and cache the second content in an upward caching block of the caching area. The one or more current-page caching blocks, downward caching block, and upward caching block are different blocks of the caching area.

Consistent with yet another embodiment of the present disclosure, a non-transitory computer-readable storage medium is provided. The medium stores instructions that, when executed by a processor, cause the processor to perform a page caching method. The method includes configuring a caching area in a memory and caching content of a currently accessed page in one or more current-page caching blocks of the caching area; determining a page accessing direction; when the page accessing direction is downward, preloading first content of at least one page that continues from the currently accessed page in the downward direction and caching the first content in a downward caching block of the caching area; and when the page accessing direction is upward, preloading second content of at least one page that continues from the currently accessed page in the upward direction and caching the second content in an upward caching block of the caching area. The one or more current-page caching blocks, downward caching block, and upward caching block are different blocks of the caching area.

It is to be understood that both the foregoing general description and the following detailed description are exemplary and explanatory only and are not restrictive of the invention, as claimed.

### DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a page caching method, according to an exemplary embodiment of the present disclosure.

FIG. 2 is a schematic diagram illustrating a caching area, according to an exemplary embodiment of the present disclosure.

FIG. 3 is a schematic diagram illustrating a caching area, according to an exemplary embodiment of the present disclosure.

FIG. 4 is a schematic diagram illustrating a caching area, according to an exemplary embodiment of the present disclosure.

FIG. 5 is a flowchart of a page caching method, according to an exemplary embodiment of the present disclosure.

FIG. 6 is a block diagram of a page caching apparatus, according to an exemplary embodiment of the present disclosure.

FIG. 7 is a block diagram of a terminal, according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

In the related art, when a user operates a computer to access a webpage upward, the content of the webpage that the user accesses needs to be loaded in real time. However, this process often needs to consume a large amount of memory resources within a short period of time. Thus, the user may have to wait a long time for the page content to be loaded. As such, the user experience in browsing the webpages is reduced.

The present disclosure provides a method for accessing webpages, including: configuring a caching area in a memory and caching content of a currently accessed page in one or more current-page caching blocks of the caching area; determining a page accessing direction; when the page accessing direction is downward, preloading first content of at least one page that continues in the downward direction from the currently accessed page, and caching the first content in a downward caching block of the caching area; and when the page accessing direction is upward, preloading second content of at least one page that continues in the upward direction from the currently accessed page, and caching the second content in an upward caching block of the caching area. The one or more current-page caching blocks, downward caching block, and upward caching block are different blocks of the caching area.

Compared to the loading of a webpage in real time, the disclosed solution preloads page content when the user accesses a webpage, thereby reducing user wait time during page loading. Thus, the computer efficiency for displaying webpages can be improved, and user experience in browsing webpages can be enhanced.

In order to make the aforementioned purpose, characteristics, and benefits of the present disclosure more evident and easier to understand, detailed descriptions are provided below of specific embodiment examples of the present disclosure in reference to the attached drawings.

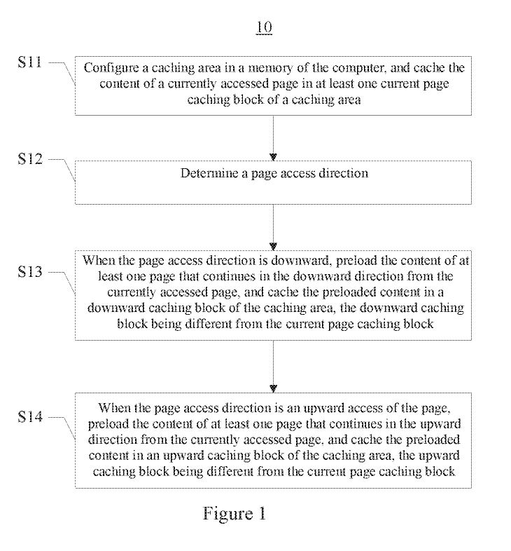

FIG. 1 is a flowchart of a page caching method 10, according to an exemplary embodiment of the present disclosure. For example, the method 10 may be performed by a processor of a computer, such as a user terminal. Referring to FIG. 1, the method 10 includes the following steps S11-S14.

In step S11, the processor configures a caching area in a memory of the computer, and caches the content of a currently accessed page in at least one current page caching block of a caching area.

In step S12, the processor determines a page access direction.

In step S13, when the page access direction is downward, the processor preloads the content of at least one page that continues in the downward direction from the currently accessed page, and caches the preloaded content in a downward caching block of the caching area. The downward caching block is different from the current page caching block.

In step S14, when the page access direction is an upward access of the page, the processor preloads the content of at least one page that continues in the upward direction from the currently accessed page, and caches the preloaded content in an upward caching block of the caching area. The upward caching block is different from the current page caching block.

In a specific embodiment of step S11, by configuring a caching area and caching the content of the currently accessed page in at least one current page caching block of the caching area, a user can have a smooth experience in accessing the current page content.

It should be noted that the location of the current page caching block is not fixed, but rather changes as the page content that the user accesses changes. The caching block whose page content is accessed by the user at any given moment can be deemed as the current page caching block.

Further, the page content may include one or more of the following: text, images, numbers, symbols, icons, video, and/or animations.

In a specific embodiment of step S12, the page access direction can be determined based on the scrolling direction of the scroll bar in the browse window. Specifically, when the scroll bar in the browse window is scrolling downward, the processor determines that the page access direction is a downward access of the page. When the scroll bar in the browse window is scrolling up, the processor determines that the page access direction is an upward access of page. It should be noted that in embodiment examples of the present disclosure, no restriction is placed on the specific approach that enables the determination of page access direction.

In a specific embodiment of step S13, when the page access direction is a downward access of the page, the content of at least one page that continues in the downward direction from the currently accessed page is obtained in advance through preloading; compared to on-site loading, user waiting time can be avoided and page display efficiency can be increased. Further, the content obtained through preloading is cached in the downward caching block of the caching area. Here, the preloading process is: when the currently accessed page is rendered in the browser window, at least a portion of content in one or a plurality of pages (e.g., a portion of the page or the entire page) under the currently accessed page is obtained in advance, so that quick rendering can be achieved by taking advantage of the preloaded content when the user slides down through the browse window.

In a specific embodiment of step S14, when the page access direction is an upward access of the page, the content of at least one page that continues in the upward direction from the currently accessed page is obtained in advance through preloading; compared to on-site loading, user waiting time can be avoided and page display efficiency can be increased. Further, the content obtained through preloading is cached in the upward caching block of the caching area. Similarly, the preloading process is: when the currently accessed page is rendered in the browser window, at least a portion of content in one or a plurality of pages (e.g., a portion of the page or the entire page) above the currently accessed page is obtained in advance, so that quick rendering can be achieved by taking advantage of the preloaded content when the user slides up through the browser window.

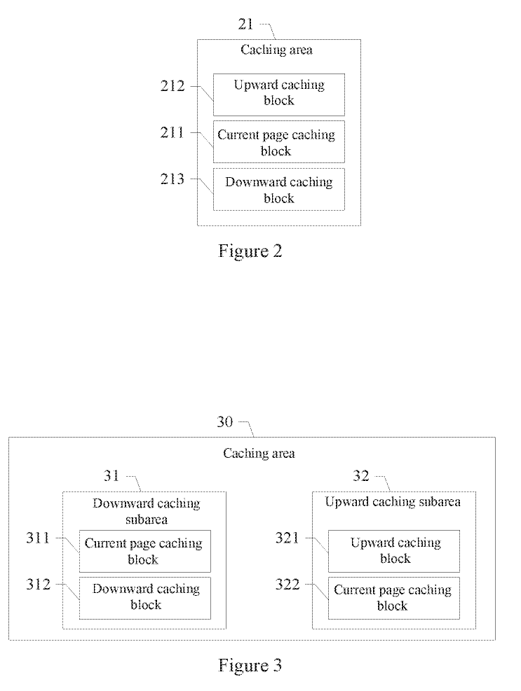

FIG. 2 is a schematic diagram illustrating a caching area 21, according to an exemplary embodiment of the present disclosure. Referring to FIG. 2, the caching area 21 includes a current page caching block 211, an upward caching block 212, and a downward caching block 213.

In some embodiments, when the page access direction is a downward access of the page, the content of at least one page that continues in the downward direction from the currently accessed page is preloaded and cached in the downward caching block 213 of the caching area. The downward caching block 213 is different from the current page caching block 211. Moreover, when the page access direction is an upward access of the page, the content of at least one page that continues in the upward direction from the currently accessed page is preloaded and cached in the upward caching block 212 of the caching area. The upward caching block 212 is different from the current page caching block 211.

In the embodiment example of the present disclosure, the page access direction is determined, and the content of at least one page that continues in the downward or the upward direction from the currently accessed page is preloaded when the page access direction is a downward or an upward access of the page. Compared to loading the page content in real time, the solution provided by the present disclosure can preload when the user accesses a page, thereby reducing user waiting time, improving page display efficiency, and enhancing user experience.

FIG. 3 is a schematic diagram illustrating a caching area 30, according to another exemplary embodiment of the present disclosure. Referring to FIG. 3, caching area 30 includes a downward caching subarea 31 and an upward caching subarea 32. The downward caching subarea 31 includes a current page caching block 311 and a downward caching block 312. That is, the current page caching block 311 and downward caching block 312 are located in the downward caching subarea 31. The upward caching subarea 32 includes an upward caching block 321 and a current page caching block 322. That is, the upward caching block 321 and current page caching block 322 are located in the upward caching subarea 32.

Further, the at least one current page caching block in step S11 (FIG. 1) may include the current page caching block 311 and/or the current page caching block 322. Each of the current page caching block 311 and the current page caching block 322 caches the content of the currently accessed page.

In the embodiment example of the present disclosure, the correlation between two caching subareas, e.g., downward caching subarea 31 and upward caching subarea 32, can be enhanced by storing the same page content in the two caching subareas. This way, when the user frequently switches the accessing direction of a webpage, the frequency for jumping between the two caching subareas to locate the desired page content can be reduced.

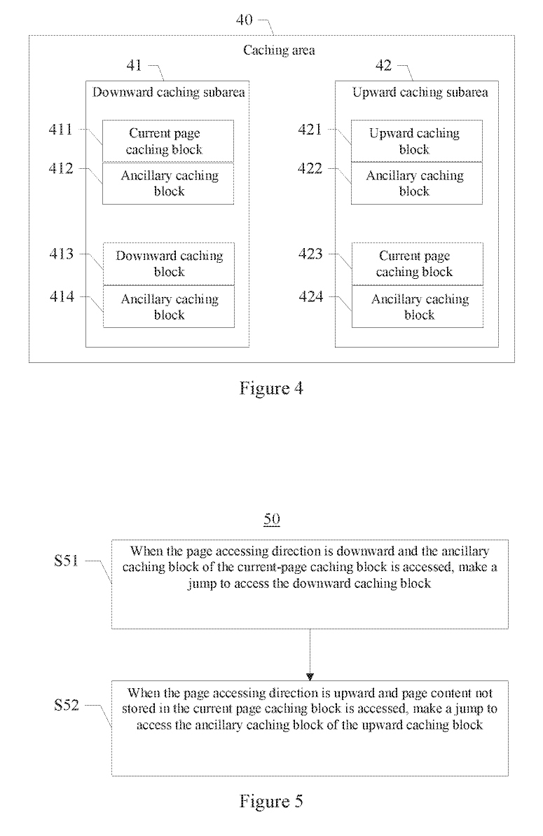

Further, at least one ancillary caching block is configured for each caching block. The page content stored in each ancillary caching block is continuous from the page content stored in the associated caching block. Each ancillary caching block is located immediately adjacent to the associated caching block. FIG. 4 is a schematic diagram illustrating a caching area 40, according to yet another exemplary embodiment of the present disclosure. As shown in FIG. 4, the caching area 40 includes a downward caching subarea 41 and an upward caching subarea 42. The downward caching subarea 41 includes a current page caching block 411, an ancillary caching block 412 of the current page caching block 411, a downward caching block 413, and an ancillary caching block 414 of the downward caching block 413. The upward caching subarea 42 includes an upward caching block 421, an ancillary caching block 422 of the upward caching block 421, a current page caching block 423, and an ancillary caching block 424 of the current page caching block 423.

It should be noted that the page content stored in each ancillary caching block is continuous from the page content stored in the associated caching block, and that each ancillary caching block is located immediately adjacent to the caching block, in order to enable the processor to continuously display the page content.

In an embodiment example of the present disclosure, greater continuity can be achieved when the jump is made from accessing the caching block to accessing the ancillary caching block as the user scrolls through the accessed page. Further, the rendering of the page to the user typically follows the sequence of the caching block's addresses in the memory, i.e., first the page content in the caching block is displayed and then the page content in the ancillary caching block adjacent to the caching block is displayed; since the page content in the ancillary caching block is continuous from the page content in the caching block, better rendering continuity can be achieved.

Further, when the page access direction is an upward access of the page, the page content stored in the ancillary caching block of the upward caching block is obtained through copying from the current page caching block. Specifically, as shown in FIG. 4, the page content stored in the upward caching block 421 is continuous in the upward direction from the page content stored in the current page caching block 423, and the page content stored in the upward caching block 421 is also continuous in the upward direction from the page content stored in the ancillary caching block 422. As such, when the storage capacity of the current page caching block 423 is the same as the storage capacity of the ancillary caching block 422, the page content stored in the current page caching block 423 is the same as the page content stored in the ancillary caching block 422. Therefore, the page content stored in the ancillary caching block 422 can be obtained through copying from the current page caching block 423.

It should be noted that the present disclosure does not require the storage capacity of the current page caching block 423 to be the same as the storage capacity of the ancillary caching block 422. In the disclosed embodiments, the page content stored in the ancillary caching block 422 can be obtained through fully or partially copying from the current page caching block 423.

In the embodiment example of the present disclosure, by copying the page content stored in an ancillary caching block from that stored in a current page caching block, the computing resources and time consumed by the copying process are far less than those consumed by the loading process. This way, computing resources can be saved and storage efficiency can be enhanced.

FIG. 5 is a flowchart of a page caching method 50, according to an exemplary embodiment of the present disclosure. For example, the method 50 may be performed by a processor of a computer, such as a user terminal. Consistent with the disclosed embodiments, the method 50 may be implemented in conjunction with the method 10, to access a webpage. Referring to FIG. 5, the method 50 includes the following steps S51 and S52.

In step S51, when the page accessing direction is downward and the ancillary caching block of the current-page caching block is accessed, the processor makes a jump to access the downward caching block.

In step S52, when the page accessing direction is upward and page content not stored in the current page caching block is accessed, the processor makes a jump to access the ancillary caching block of the upward caching block.

In a specific embodiment of step S51, the page content stored in the current page caching block is continuous in the downward direction from the page content stored in the downward caching block, and the page content stored in the current page caching block is also continuous in the downward direction from the page content stored in the ancillary caching block of the current page caching block. As such, when the storage capacity of the ancillary caching block of the current page caching block is the same as the storage capacity of the downward caching block, the page content stored in the ancillary caching block of the current page caching block is the same as the page content stored in the downward caching block. Therefore, if an access is made to the ancillary caching block of the current page caching block, the processor can make a jump to access the downward caching block, resulting in no change in the page displayed to the user terminal, i.e. the user experiences no discontinuity in the content.

Further, since an ancillary caching block of the downward caching block is configured, and the page content stored there is continuous from the page content stored in the downward caching block, greater continuity can be achieved when the jump is made from accessing the downward caching block to accessing the ancillary caching block of the downward caching block, as the user scrolls through the accessed page.

It should be noted that the present disclosure does not require the storage capacity of the ancillary caching block of the current page caching block to be the same as the storage capacity of the downward caching block. In some embodiments, when the ancillary caching block of the current page caching block and the downward caching block have different storage capacities and therefore the page content stored therein are only partially the same, the processor can access the ancillary caching block of the current page caching block up to the same page content, and then makes the jump from the ancillary caching block to the downward caching block. This way, the user will experience no discontinuity in the displayed page content.

In a specific embodiment of step S52, the page content stored in the upward caching block is continuous in the upward direction from the page content stored in the current page caching block, and the page content stored in the upward caching block is also continuous in the upward direction from the page content stored in the ancillary caching block. As such, when the storage capacity of the current page caching block is the same as the storage capacity of the ancillary caching block, the page content stored in the current page caching block is the same as the page content stored in the ancillary caching block. Therefore, if an access is made to content outside of the page content stored in the current page caching block, then a jump will be made to access the ancillary caching block of the upward caching block, resulting in no change in the page displayed to the user's terminal, i.e., the user experiences no discontinuity in the content.

Further, since the page content stored in the ancillary caching block of the upward caching block is continuous from the page content stored in the upward caching block, greater continuity can be achieved when the jump is made from accessing the ancillary caching block of the upward caching block to accessing the upward caching block as the user scrolls through the accessed page.

It should be noted that the present disclosure does not require the storage capacity of the ancillary caching block of the upward caching block to be the same as the storage capacity of the current page caching block. In some embodiments, when the ancillary caching block of the upward caching block and the current page caching block have different storage capacities and therefore the page content stored therein are only partially the same, the processor can access the current page caching block up to the same page content, and then makes the jump from the current page caching block to the ancillary caching block of the upward caching block. This way, the user will experience no discontinuity in the displayed page content.

In the embodiment example of the present disclosure, since the page content stored in the ancillary caching block of the current page caching block is the same as the page content stored in the downward caching block, and the page content stored in the current page caching block is the same as the page content stored in the ancillary caching block of the upward caching block, when accessing content outside of the page content stored in the current page caching block, a jump can be made so that the page content seen by the user remains continuous, which achieves greater display smoothness when scrolling up or down through the page.

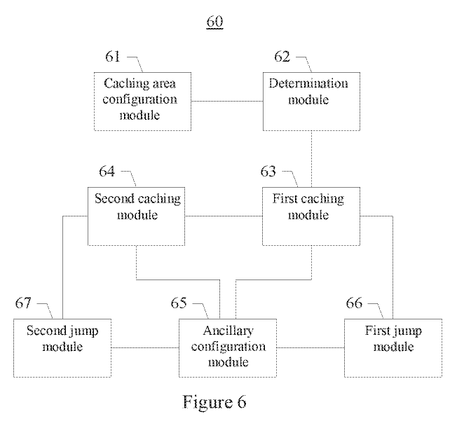

FIG. 6 is a block diagram of a page caching apparatus 60, according to an exemplary embodiment of the present disclosure. Referring to FIG. 6, the apparatus 60 includes a caching area configuration module 61, a determination module 62, a first caching module 63, a second caching module 64, an ancillary configuration module 65, a first jump module 66, and a second jump module 67.

Here, the caching area configuration module 61 configures a caching area in a memory and caches the content of the currently accessed page in at least one current page caching block of the caching area.

The determination module 62 determines the page access direction.

The first caching module 63 preloads the content of at least one page that continues in the downward direction from the currently accessed page, and caches the preloaded content in the downward caching block of the caching area, when the page access direction is a downward access of the page. The downward caching block is different from the current page caching block.

The second caching module 64 preloads the content of at least one page that continues in the upward direction from the currently accessed page, and caches the preloaded content in the upward caching block of the caching area, when the page access direction is an upward access of the page. The upward caching block is different from the current page caching block.

The ancillary configuration module 65 configures at least one ancillary caching block for each caching block. The page content stored in the ancillary caching block is continuous from the page content stored in the caching block. Each ancillary caching block is immediately after the caching block.

The first jump module 66 is configured to make a jump to access the downward caching block when an access is made to the ancillary caching block of the current page caching block and the page access direction is a downward access of the page.

The second jump module 67 is configured to make a jump to access the ancillary caching block of the upward caching block when an access is made to content outside of the page content stored in the current page caching block and the page access direction is an upward access of the page.

Further, the page access direction is determined based on the scrolling direction of the scroll bar in the browse window.

Further, the caching area may include an upward caching subarea and a downward caching subarea, the downward caching block is located in the downward caching subarea, and the upward caching block is located in the upward caching subarea.

Further, the at least one current page caching block includes the current page caching block in the upward caching subarea and the current page caching block in the downward caching subarea.

Furthermore, when the page access direction is an upward access of the page, the page content stored in the ancillary caching block of the upward caching block is obtained through copying from the current page caching block.

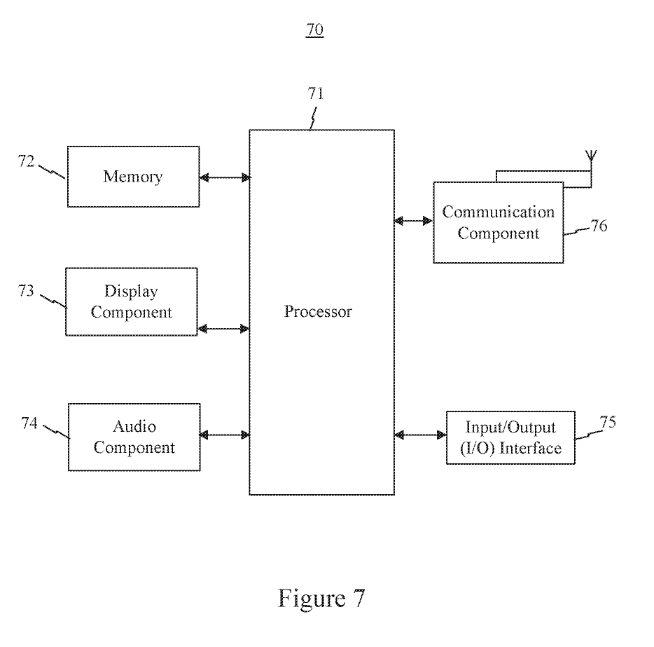

FIG. 7 is a block diagram of a terminal 70, according to an exemplary embodiment of the present disclosure. For example, the terminal 70 may include a part or the whole of the aforementioned page caching apparatus 60 (FIG. 6). Referring to FIG. 70, the terminal 70 includes a processor 71, a memory 72, a display component 73, an audio component 74, an input/output (I/O) interface 75, and a communication component 76.

The processor 71 typically controls overall operations of the terminal 70, such as the operations associated with display, telephone calls, data communications, browsing webpages, etc. The processor 71 is configured to execute instructions to perform all or part of the steps in the above described methods. Moreover, the processor 71 may include one or more modules which facilitate the interaction between the processor 71 and other components. For instance, the processor 71 may include a multimedia module to facilitate the interaction between the display component 73 and the processor 71.

The memory 72 is configured to store various types of data to support the operation of the terminal 70. Examples of such data include instructions for any applications or methods operated on the terminal 70, webpage content, messages, pictures, video, etc. The memory 72 may also include the disclosed caching areas for storing the webpage content (e.g., the caching areas illustrated in FIGS. 2-4), including the disclosed current page caching blocks, upward catching blocks, downward caching blocks, ancillary caching blocks, etc. The memory 72 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The display component 73 includes a screen providing an output interface between the terminal 70 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In the disclosed embodiment, the processor 71 may control the display component 73 to display a webpage.

The audio component 74 is configured to output and/or input audio signals. For example, the audio component 74 includes a speaker to output audio signals related to the webpage displayed by the display component 73. The audio component 74 may also include a microphone configured to receive an external audio signal when the terminal 70 is in an operation mode, such as a call mode, a recording mode, and a voice recognition mode.

The I/O interface 75 provides an interface between the processor 71 and peripheral interface modules of the terminal 70, such as a keyboard, a click wheel, buttons, and the like. The buttons may include, but are not limited to, a home button, a volume button, a starting button, and a locking button. In the disclosed embodiments, the I/O interface 75 may receive, from the peripheral interface modules, a user command for accessing a webpage. For example, the user command may include the Uniform Resource Locator (URL) of a webpage that the user wants to access. For another example, the user command may be scrolling up or down a webpage currently displayed in the display component 73. The I/O interface 75 relays the user command to the processor 71, which then performs the disclosed methods to display a webpage.

The communication component 76 is configured to facilitate communication, wired or wirelessly, between the terminal 70 and other devices. The terminal 70 can access a wireless network based on a communication standard, such as WiFi, 2G, 3G, 4G, 5G, or a combination thereof. In one exemplary embodiment, the communication component 76 receives a broadcast signal or broadcast associated information from an external broadcast management system via a broadcast channel. In one exemplary embodiment, the communication component 76 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies. In the disclosed embodiments, the terminal 70 can access webpage content stored in a remote computer, e.g., a server, via the communication component 76.

In exemplary embodiments, the terminal 70 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 72, executable by the processor 71 in the terminal 70, for performing the above-described methods. For example, the non-transitory computer-readable storage medium may be a read-only memory, a random access memory (RAM), a CD-ROM, a magnetic tape, a floppy disc, an optical data storage device, and the like.

For more details about the page caching apparatus 60 and the terminal 70, please refer to the relevant descriptions of the page caching method in the previous text and FIGS. 1-5. No redundant description will be detailed here.

Notwithstanding the above disclosure of the present disclosure, it does not restrict the present disclosure. Any person of skill in the art may make various alterations and changes that are not detached from the spirit and scope of the present disclosure; therefore, the scope of protection for the present disclosure should be that as defined by the claims.

What is claimed is:

1. A computer-implemented page caching method, comprising:
configuring a caching area in a memory and caching content of a currently accessed page in one or more current-page caching blocks of the caching area;
determining a page accessing direction;
when the page accessing direction is downward, preloading first content of at least one page that continues in the downward direction from the currently accessed page, and caching the first content in a downward caching block of the caching area; and
when the page accessing direction is upward, preloading second content of at least one page that continues in the upward direction from the currently accessed page, and caching the second content in an upward caching block of the caching area,
wherein the one or more current-page caching blocks, downward caching block, and upward caching block are different blocks of the caching area.

2. The method according to claim 1, wherein determining the page accessing direction comprises:
determining the page accessing direction based on a scrolling direction of a scroll bar in a browsing window.

3. The method according to claim 1, wherein the caching area includes an upward caching sub-area and a downward caching sub-area, wherein the upward caching block is located in the upward caching sub-area, and the downward caching block is located in the downward caching sub-area.

4. The method according to claim 3, wherein the one or more current-page caching blocks include at least one current-page caching block located in the upward caching sub-area and at least one current-page caching block located in the downward caching sub-area.

5. The method according to claim 1, wherein each caching block of the caching area has associated therewith an ancillary caching block located immediately adjacent to the associated caching block, the ancillary caching block storing page content continuous from the page content stored in the associated caching block.

6. The method according to claim 5, wherein
when the page accessing direction is upward, the page content stored in the ancillary caching block of the upward caching block is copied from the page content stored in the one or more current-page caching blocks.

7. The method according to claim 5, further comprising:
when the page accessing direction is downward and the ancillary caching block of the current-page caching block is accessed, jumping to access the downward caching block; and
when the page accessing direction is upward and page content not stored in the current page caching block is accessed, jumping to access the ancillary caching block of the upward caching block.

8. An apparatus, comprising:
a memory storing instructions; and
a processor configured to execute the instructions to:
configure a caching area in the memory and cache content of a currently accessed page in one or more current-page caching blocks of the caching area;
determine a page accessing direction;
when the page accessing direction is downward, preload first content of at least one page that continues in the downward direction from the currently accessed page, and cache the first content in a downward caching block of the caching area; and
when the page accessing direction is upward, preload second content of at least one page that continues in the upward direction from the currently accessed page, and cache the second content in an upward caching block of the caching area,
wherein the one or more current-page caching blocks, downward caching block, and upward caching block are different blocks of the caching area.

9. The apparatus according to claim 8, wherein the processor is further configured to execute the instructions to:
determine the page accessing direction based on a scrolling direction of a scroll bar in a browsing window.

10. The apparatus according to claim 8, wherein the caching area includes an upward caching sub-area and a downward caching sub-area, wherein the upward caching block is located in the upward caching sub-area, and the downward caching block is located in the downward caching sub-area.

11. The apparatus according to claim 10, wherein the one or more current-page caching blocks include at least one current-page caching block located in the upward caching sub-area and at least one current-page caching block located in the downward caching sub-area.

12. The apparatus according to claim 8, wherein the processor is further configured to execute the instructions to:
set an ancillary caching block for each caching block of the caching area, so that each caching block has associated therewith an ancillary caching block, the ancillary caching being located immediately adjacent to the associated caching block and configured to store page content continuous from the page content stored in the associated caching block.

13. The apparatus according to claim 12, wherein the processor is further configured to execute the instructions to:
when the page accessing direction is upward, generate the page content stored in the ancillary caching block of the upward caching block by copying from the page content stored in the one or more current-page caching blocks.

14. The apparatus according to claim 12, wherein the processor is further configured to execute the instructions to:
when the page accessing direction is downward and the ancillary caching block of the current-page caching block is accessed, jump to access the downward caching block; and
when the page accessing direction is upward and page content not stored in the current page caching block is currently accessed, jump to access the ancillary caching block of the upward caching block.

15. A non-transitory computer-readable storage medium storing instructions that, when executed by a processor, cause the processor to perform a method comprising:
configuring a caching area in a memory and caching content of a currently accessed page in one or more current-page caching blocks of the caching area;
determining a page accessing direction;
when the page accessing direction is downward, preloading first content of at least one page that continues in the downward direction from the currently accessed page, and caching the first content in a downward caching block of the caching area; and
when the page accessing direction is upward, preloading second content of at least one page that continues in the upward direction from the currently accessed page, and caching the second content in an upward caching block of the caching area,
wherein the one or more current-page caching blocks, downward caching block, and upward caching block are different blocks of the caching area.

16. The medium according to claim 15, wherein determining the page accessing direction comprises:
determining the page accessing direction based on a scrolling direction of a scroll bar in a browsing window.

17. The medium according to claim 15, wherein the caching area includes an upward caching sub-area and a downward caching sub-area, wherein the upward caching block is located in the upward caching sub-area, and the downward caching block is located in the downward caching sub-area.

18. The medium according to claim 17, wherein the one or more current-page caching blocks include at least one current-page caching block located in the upward caching sub-area and at least one current-page caching block located in the downward caching sub-area.

19. The medium according to claim 15, wherein each caching block of the caching area has associated therewith an ancillary caching block located immediately adjacent to the associated caching block, the ancillary caching block storing page content continuous from the page content stored in the associated caching block.

20. The medium according to claim 19, wherein
when the page accessing direction is upward, the page content stored in the ancillary caching block of the upward caching block is copied from the page content stored in the one or more current-page caching blocks.
